(19) United States
(12) Patent Application Publication
(10) Pub. No.: US 2013/0036139 A1
(43) Pub. Date: Feb. 7, 2013

(54) Travel Planning Decision Tool

(71) Applicants: Dacia Kung, Spring, TX (US); Richard Kung, Spring, TX (US)

(72) Inventors: Dacia Kung, Spring, TX (US); Richard Kung, Spring, TX (US)

(73) Assignee: Kung Solutions, LLC, Spring, TX (US)

(21) Appl. No.: 13/195,625

(22) Filed: Aug. 1, 2011

(51) Int. Cl. G06F 17/30

(52) U.S. Cl. 707/780; 707/E17.107

(57) ABSTRACT

Described is a method of organizing travel between a plurality of travelers by allowing a first traveler to specify criteria and preferences for a trip, finding a plurality of destinations which match the criteria and preferences, then allowing the travelers to rank and vote for each destination. Once one traveler selects a trip based on the ranking, the traveler may invite the other travelers to join them on the trip.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Travel planning can be difficult. Vacation travel can be especially difficult to plan due to the overwhelming number of options available to today's traveler. Most travel planning is based on the traveler knowing where they want to go, how they want to get there, and what they want to do. But, it is not always the case that a traveler has all the details determined. Further, travelers who have determined the details of their travel may simply be settling for a less than optimal trip because they are unaware of other options available to them. When multiple people are attempting to plan a trip together it can be very difficult to find a trip that meets the needs of each traveler.

There are an overwhelming number of travel options facing the standard traveler, to the point that most people tend to take the standard vacations in the standard locations, using the standard itinerary without exploring other options. Now package deals are offered to travelers which group the standards together into a single offering because so many people choose them. Travelers remain unaware of options which they may have enjoyed because they don't have a means of discovering all the options available to them. Determining travel options can be further complicated by multiple travelers with different preferences, agendas, and characterizes. Travelers are unique individuals. Travel groups are unique. The current travel industry and offerings do not recognize this and attempt to fit everyone into standard categories leaving most travelers with an unsatisfying experience.

### BRIEF DESCRIPTION OF THE DRAWINGS

FIG. 1 illustrates the process for establishing a traveler criteria and traveler profile in accordance with an exemplary embodiment of the invention.

FIG. 2 shows the use of a social network to establish relationships in matching travel companions in accordance with an exemplary embodiment of the invention.

FIG. 3 illustrates data acquisition which shows how data is classified in accordance with an exemplary embodiment of the invention.

FIG. 4 show a traveler information query flow chart in accordance with an exemplary embodiment of the invention..

FIG. 5 shows a group travel flowchart in accordance with an exemplary embodiment of the invention.

FIG. 6 shows a destination match flowchart in accordance with an exemplary embodiment of the invention.

FIG. 7 shows an alternative destination match flowchart in accordance with an exemplary embodiment of the invention.

### DETAILED DESCRIPTION OF THE PREFERRED EMBODIMENTS

Described herein is a travel planning decision tool implementing a travel planning method which may be incorporated into a website that allows a user to map out and discover new travel destinations using a single process. The tool aids travelers who have preferences, but not specific arrangements for their travels. The tool streamlines the earliest phases of travel planning by matching criteria from travelers to characteristics of travel destinations, methods of travel and activities. The goal of the tool is to allow user to book travel in a simple fashion, avoiding information overload, as well as allowing the user to explore various travel options. The destination city, timeframe, and overall type of trip are variables that the user can explore through the website, which uses an algorithm to suggest different options given the user preferences.

The tool uses information provided by the user through an interaction system. To determine who is/are the traveler(s), why they want to travel, what are their goals for the trip, where are their destinations, when do they want to travel, how do they prefer to travel, a series of questions are asked of the user. The questions are adaptive where later questions and default answers are determined based on the earlier answers. For example, someone attending a conference is presumed to want a room in the conference hotel, or a nearby location, rather than a resort several miles away. However, someone visiting a city for vacation may desire the resort over a hotel in the downtown area. The system may determine some of this information by direct query of the user, one example would be “When is the earliest you could leave?” and “When do you need to return?” Another method for determining information is by indirect query of the user. One example would be “You have chosen your key travel destination as the Convention Center in Houston, Tex. Are you attending a specific event? Do you want to attend the entire event?” Another method would be determining information by accessing other user content. One example would be “According to your calendar system, you are free to travel from July 1 to July 17^{th}. Do you want to find itineraries based on these dates?” Another method would be determining information by accessing information from another user. An example would be using connections on a social network to facilitate group travel. “You indicated you would like to travel with ‘Kathy K.’ from your Facebook alumni association group. She has indicated she is available for two consecutive weeks between April 26^{th} and June 8^{th}. Do you accept this travel window?”

Through the use of social networking sites, the travel tool can enhance a user's trip in a number of ways. By publishing general travel preferences, one may find friends and family who would like to share a trip. Stating that I like to camp and desire to travel to Minnesota, I may find that two friends from college have been planning a similar trip, and would like to go together. By comparing a travel destination to other information available on a social networking site, a traveler may find that an old friend from their hometown now lives in the city the traveler is visiting for a conference and together they plan an evening dinner to catch-up.

A user may maintain a set of standard information in a travel profile, or a database so that later trips are planned more efficiently, or economically. If the users frequent flyer programs, and hotel rewards memberships are accessible by the tool, then accommodations could be recommended accordingly. In one example, when comparing two hotel rooms in the same city, on the same night, the cost may be identical, but a traveler belonging to the membership rewards program of one of the hotels would prefer that one given a choice. Further, a travel may prefer to use “Hotel M” because they can redeem their rewards for a lower rate, but the travel tool may find that even with the redemption, “Hotel Q” has a lower price. If three friends are traveling together, and two of them belong to the “Hotel R” rewards program, then “Hotel R” would be a preferred hotel choice for the group.

By planning an entire itinerary a user can fully understand all of the options of their travel. Given an itinerary one can determine, bus, subway or cab options for transportation. Further a person could determine if staying at a more expensive hotel in town and taking cabs to destinations would be more economically feasible to staying at a lower priced hotel outside of town and renting a vehicle for the trip duration.

The tool is separated into multiple stages. In one stage, the user a) plans a multi-destination trip given a time frame, b) determines the best times of year to visit a given destination, and c) decides between multiple destinations and activities given the desired times to travel. Someone planning a trip to Mount Rushmore in late July or early August may not be aware that it is a common point for motorcyclist heading to or from Sturgis Bike Week at that time of year, so campgrounds and motels are often full.

Once all the user information is provided, the second stage of the tool allows the user to plan out the trip in a map and or calendar format, book travel, display sample itineraries, and consider suggested vacation packages and itineraries. For example, the system may suggest that staying over the weekend would cause the air fare savings to off-set the additional lodging expenses making an extra weekend at a destination practically free of additional cost. Suggestions are made based on preferences specified by the user where similar activities in nearby areas are offered for the traveler's consideration. For example, someone interested in sculpture interested in traveling to Mount Rushmore may not be aware of the Crazy Horse monument actively under construction just 20 miles away. An arborist traveling from San Jose, Calif. to Santa Cruz, Calif. may take the Santa Cruz Hwy and miss an opportunity to visit the towering Redwoods of Henry Cowell State Park.

The third stage comprises an itinerary of the travel trip, expected costs associated with the trip, and a travel checklist supplied to the user based on the preferences chosen by the user.

A traveler checklist may comprise the following:
Documentation: Passport and Visa requirements, government regulations associated with travel in the area, TSA and airline travel requirements, etc.;
Health concerns: recommended vaccines, travel advisories issued for the areas, etc.;
Movement concerns: areas to be avoided by tourist, activities to avoid, signs to watch for to avoid trouble, etc.;
Packing assistance: average historical weather for advanced travel dates, or actual weather predictions for near travel date; electrical converter requirements for accessories, coupons or discounts on travel related items, airline luggage restrictions;
Activity checklist: equipment checklist for specific activities; basic traveler phrase pamphlets for areas in which the traveler will be passing through, and more extensive phrase books for areas where a traveler will stay for extended time frames;
Traveler Information: brochures and pamphlets for area attractions, historic information about an area, its people, and cultures, guides for tipping;
Financial information: monetary primer for the area; travelers check and banking locations in the areas; coupons, discounts, etc for area activities, goods and services.

The Travel planning decision tool allows a user to handle all aspects of travel planning by helping the user to plan, evaluate, design, execute, and maintain their travel plans from start to finish. The criteria of the travelers are determined by asking a series of questions that determine travel needs and preferences. A plurality of travel options are then presented from which the traveler may choose, or the traveler may be present with further questions to further narrow choices.

A plurality of travelers may use the travel tool to enter characteristics from each traveler and travel options are presented based on the overlapping preferences of each traveler. In another embodiment the use of social networking sites are used to match travelers with other friends and acquaintances who may be considering similar travel to see if they may want to link their trips.

A traveler answers queries or otherwise presents characteristics and preferences about themselves to help determine the travel recommendation. Such preferences might include, but is not limited to, desired activities, reasons for travel, modes of transportation, length of stay, cost range of the trip, age group of the traveler, sex of the traveler, health issues. Further, travel preferences can be determined from other personal traveler preferences including, but not limited to, hobbies, interest, occupation, and prior travel details.

From the above information, general travel plans can be determined such as the destination and season. Further queries can be used to narrow options presented to the travelers. For instance, if one or more traveler has indicated a fear of flying, then travel by air would not be presented as a possible travel option. Further, if a plurality of travelers has indicated they belong to specific travel rewards programs, then certain accommodations would be ranked higher in the presented options.

Travel plans are determined by algorithms which considered the information provided by the user(s) and ranks destinations and times to best meet the anticipated needs of the user. Data provided is grouped into six basic questions Who, Why, Where, When, What, & How.

Who and Why depend on When and Where. For example, business trips (Why) can be done at specific times of year (When) and to specific locations (Where), so the variables to be determined are How to travel, and What other activities, if any, can be accommodated during the trip. Another example is that who depends on When and Where. Teachers (Who) often find it difficult to plan vacations to relaxing beach destinations or ski resorts (Where) because their travel opportunities often coincide with traditional student travel plans (When) which change the dynamic of the desired destinations. Further, someone looking to travel on a limited budget would find more economical travel by attending less popular locations, or attending the popular locations at off-peak times.

When may depend on What and Where. For example, skiing trips to Colorado can only be done when there is snow in the mountains. Further, if it is currently closer to the season, then a larger window may be open for planning When because current weather conditions are known or can be predicted with greater accuracy. If a user is planning a skiing trip eight months in advance, then they are better off planning for a smaller window in the middle of the season where late snowfall or early warming are less likely to affect skiing conditions.

What may depend on both Where, and possibly When. For example skiing is dependent on location (Where), time of year winter, late fall, or early spring (When). Visiting the Pyramids can only be done in Egypt. If you want to fish for Marlin, then there are different seasons (When) based on the location (Where).

The travel planning decision tool uses algorithms which rank options based on how closely they match the travel criteria determined from the data acquired from the user. Options are then ranked for closeness match and the top choices are presented to the user for selection. Probability indicates that the user is most likely to select one of the closest matches to their criteria. A user who does not find an acceptable option from the selection presented may chose to view additional options which ranked lower, or to adjust the criteria and begin the process again.

The Best Time algorithm determines the best time to travel to a specific destination. The climate is matched with the desired climate for the traveler's desired activities. Natural disasters are evaluated for likelihood, when possible. For example, an area prone to flooding is more likely to flood during the rainy season, and less likely to flood during the dry season. Areas near the Gulf of Mexico are more likely to experience unpredictable weather extremes during hurricane season. Avalanches are more likely to occur later in the snow season when accumulations are higher and rising temperatures begin to make successive levels of coverage less stable. Health risks are also evaluated for likelihood, when possible. For example, malaria is more likely during times when mosquito populations are at their highest due to wet conditions and warm weather. Travel advisories are evaluated based on the threat level advised by the advising agency. These elements are then weighted and combined to determine a rating comparing one time period to another for the given destination and from this a best time to visit a destination is determined.

The Tourist Season algorithm determines when peak travel to an area occurs. It is established as a high, mid, and low season rating. The rating is determined by the number of travelers each month for a yearly period. The number of travelers can be determined in different way for different destinations. All determinations should be relatively accurate for a given method across the yearly period. For example, travel to an island destination can be determined by air passenger arrivals and departures, or hotel guest. Both trends should yield similar results for a given area. In a national park, then visitors are carefully monitored by park service officials who require registration when entering and leaving the park. Traditional tourist destinations have established general times, but may not have quantified the actual seasons.

The Effective Time algorithm is defined as the optimal stay needed at a location plus the travel time to the location plus or minus time zone differences. The effective time can be established for a given destination, and then modified depending on the traveler. If optimal stay is established to be 3 days and 2 nights, then a family with young children or the elderly may find that and additional day is optimal to account for a slower pace. Trends in the effective time for a given destination are determined by advised times recommended by the destination's industry and feedback from previous travelers to the same or similar destinations. The Traveler's time available must be equal to or greater than the effective time for a destination, or the destination is not a match for that traveler. Where there are a number of locations within a close proximity, then the optimal stay may include a sum of the optimal stay at the different locations. If the traveler's time available is greater than the effective time for a single destination, and less than the effective time for all locations, then the list of locations may be presented to the user along with ratings for suitability determined by other traveler criteria.

The how much algorithm is defined as the total expected cost for a destination, this includes accommodation cost, travel cost, food cost, and entertainment cost. These cost are then weighted and adjusted based on tourist season, length of stay, and number of travelers. A traveler budget must be equal to or greater than the how much algorithm's value for the destination.

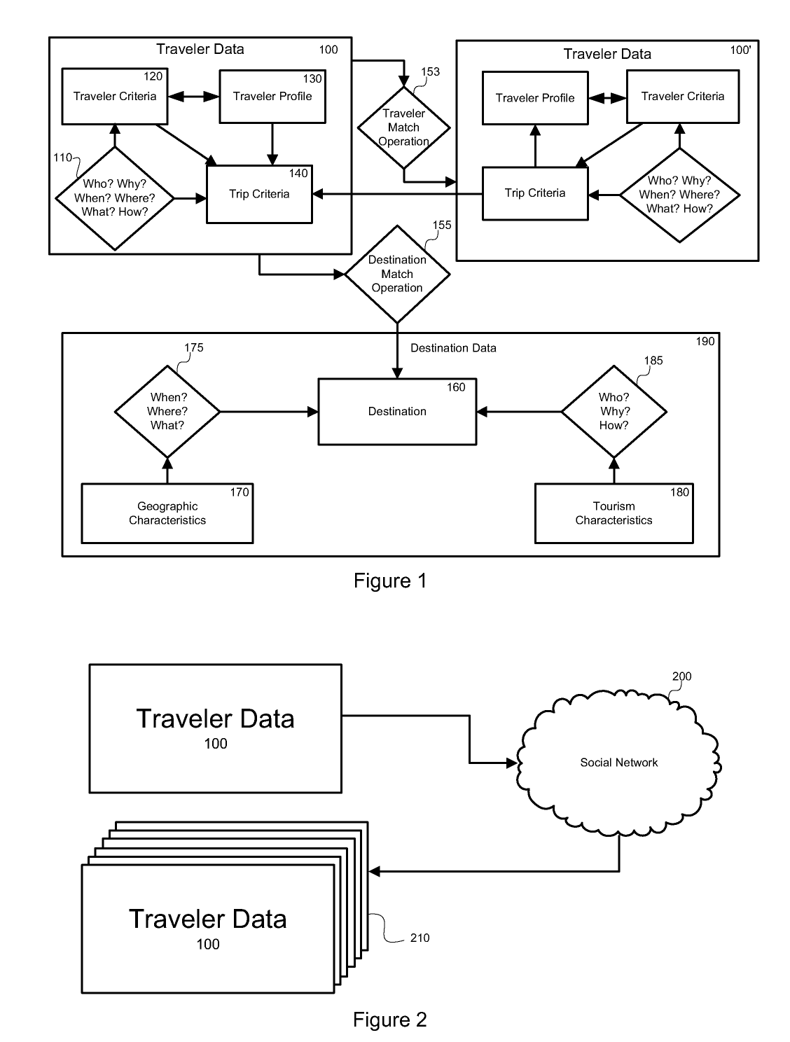

FIG. 1 illustrates how a traveler (100) is queried (110) to establish their traveler criteria (120) and their traveler profile (130). The traveler profile contains information such as physical characteristics: sex, age, citizenship, frequent flyer numbers, hotel discount and rewards program memberships, smoker/non-smoker, aerophobic, hydrophobic, aquaphobic, prefers first floor accommodations, etc. The traveler profile (130) may be maintained between sessions in a database and only needs to occasionally be updated, as it is less dynamic than traveler criteria (120).

Traveler criteria (120) is more trip specific. A traveler may not specify one of a plurality of traveler criteria (120) to be used on a specific trip. That is to say the traveler is interested in any type of travel destination that the tool can match for them. In another instance, the traveler may specify, from a database, previously saved traveler criteria. Then one or more of their traveler criteria records is used/combined to create the traveler criteria (120) for use in the search tool session. Traveler Criteria (120) may contain traveler specific information such as scuba diver, snow skier, backpacker, food connoisseur, interest in religious sites, bicycler, etc. The traveler profile will always be used, but the traveler criteria may be specified if the traveler is interested in a certain type of travel, otherwise, a conglomeration of all previous traveler criteria specified will be considered since each traveler criteria record represents a possible trip in which the traveler has previously expressed interest.

Once the traveler profile (130) and the travel criteria (120) information have been populated, the trip criteria (140) is generated by additional queries (110) which gather information, or determine which information should be incorporated into the trip criteria (140) as relevant from the travel criteria (120) and traveler profile (130). For instance, if someone has specified they are interested in a cross-country motorcycle and camping trip, then frequent flyer numbers and hotel rewards programs stored in their traveler profile (130) may not be relevant. The system then uses a series of algorithms, described below, through a match operation (155) to establish a plurality of destinations (160) from which the traveler (100) can chose. The Traveler Profile (130) can also be matched (153), along with travel criteria (120) to that of other travelers (100′). This information regarding other similar travelers (100′) and their trip criteria (140′) from other sessions, is used as a weighting factor to establish how the plurality of destinations (160) are presented to the traveler (100) under the assumption that people with similar characteristics may prefer similar decisions.

Destinations (160) are data records in a destination data collection (190) comprised of geographic characteristics (170) established by geographic categorizing (175) and tourism characteristics (180) established by tourism categorizing (185). Geographic categorizing (175) and tourism categorizing (185) are initially accomplished by gathering information from traditional sources such as travel databases, tourism guides, climate guides, and expert analysis. User feedback and ranking is further used to adjust the initial data over time by asking travelers to respond to surveys of their experiences after a trip.

FIG. 2 shows the use of a social network (200) to establish relationships in matching travel companions. The social network (200) account, such as Facebook, MySpace, Google+, etc., is associated with a traveler record (100). The social network (200) establishes existing relationships between one or more travelers, and their travel profiles (100) are compared to generate a plurality of potential travel companions (200) based on similar travel plans or trip criteria.

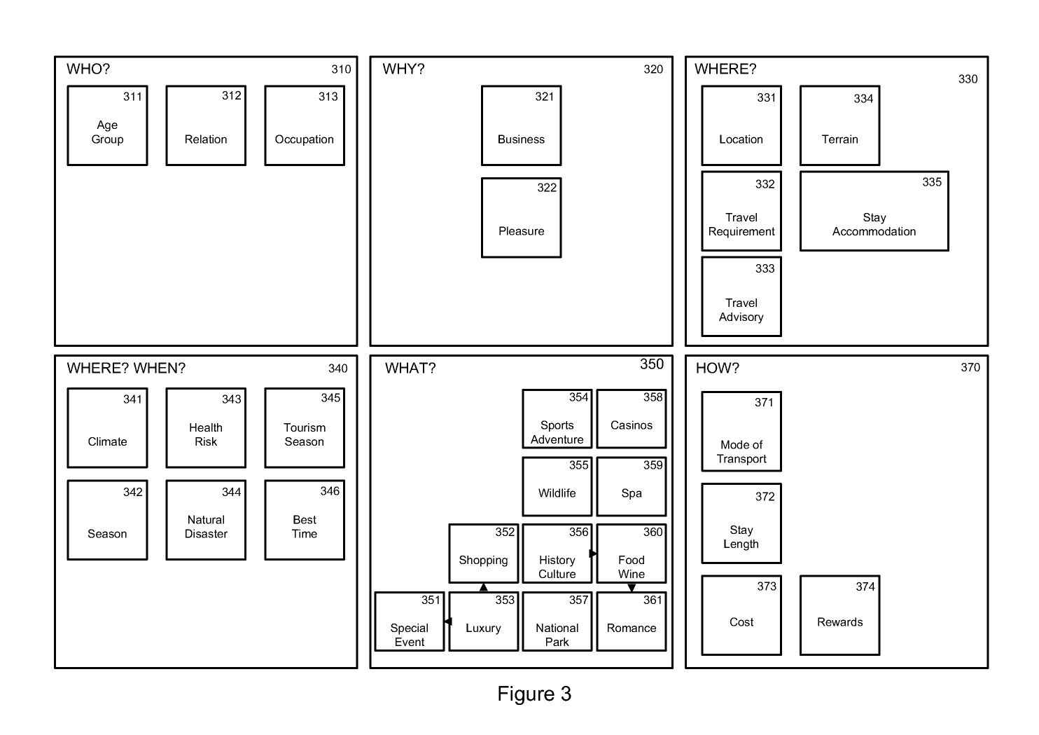

FIG. 3 illustrates data acquisition which shows how data is classified and examples of the data to be included under each classification. Data classification (300) divides the data according to which of the basic questions are best answered by such data. Under the who data classification (310) examples would include, but not be limited to: age group (311), relation (312), used to establish multiple party travel, and occupation (313). In the why data classification (320) examples would include, but not be limited to: business (321), and pleasure (322). The where data classification (330) would include, but not be limited to the following examples: location (331), travel requirement (332), travel advisory (333), terrain (334), stay accommodation (335). Under the when data classification (340) examples would include, but not be limited to: climate (341), season (342), health risk (343), natural disaster (344), tourism season (345), best time (346). In the what data classification (350) examples would include, but not be limited to: special event (351), shopping (352), luxury (353), sports adventure (354), wildlife (355), history / culture (356), national parks (357), casinos (358), spa (359), food/wine (360), romance (361). The how data classification (370) would include, but not be limited to the following: mode of transportation (371), stay length (372), cost (373), rewards (374).

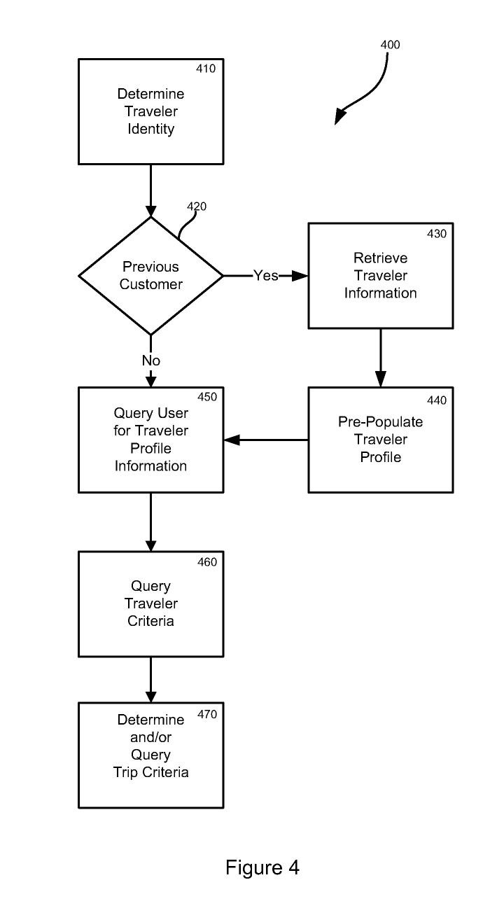

FIG. 4 show the traveler information query flow chart (400). The traveler information query flowchart (400) shows the process of determining traveler profile (130), traveler criteria (120), and trip criteria (140) information prior to conducting a search for potential destinations (190). First a traveler's identify must be determined (410). If the traveler is a previous customer (420) then a data may already be known from previous session. The system retrieves the traveler information (430) from the previous session. Once any previous information has been used to pre-populate the traveler profile (440), the traveler is queried for any traveler profile information (450). Next specific information about the type of trip is determined by querying the traveler for the travel criteria (460). Next the information in the traveler criteria is supplemented with information in the traveler profile to establish the trip criteria, and the traveler is queried about any remaining information that may be necessary to establish a full trip criteria (470).

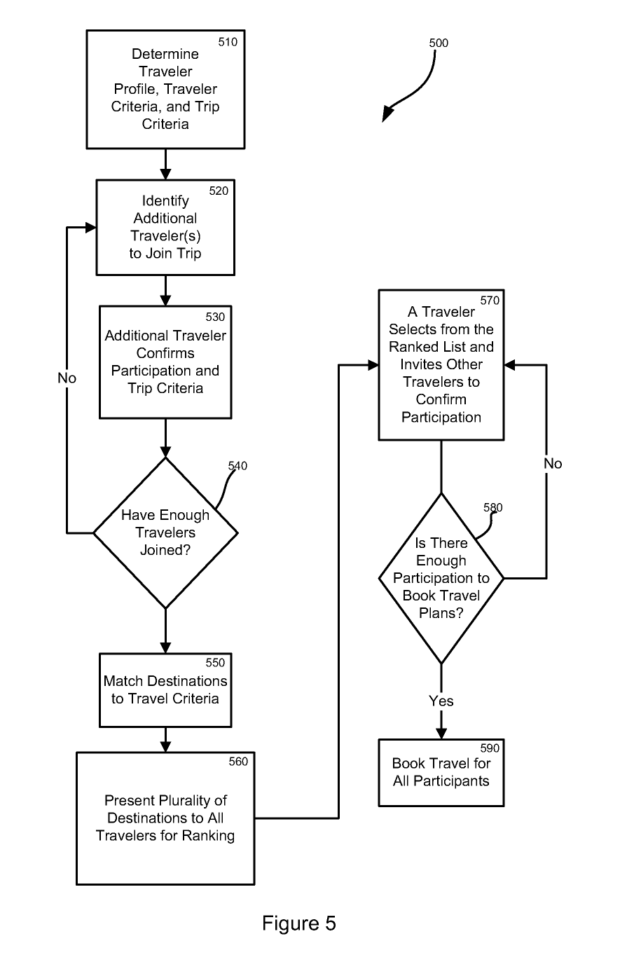

FIG. 5 shows the group travel flowchart (500). The group travel flowchart (500) shows the process of determining travel destinations for a group of travelers. First a traveler must establish their traveler profile, traveler criteria, and trip criteria (510) by a process similar to that illustrated in FIG. 4. Next a traveler will identify additional travelers to join the trip (520). This may be through the use of a social network, such as illustrated in FIG. 2. The other travelers may then choose to establish their own traveler profile and traveler criteria within the system by a process similar to that illustrated in FIG. 4. Next, one or more additional travelers confirms that they wish to participate in the trip as defined by the trip criteria (140). One or more of the additional travelers confirm participation and the trip criteria (530). If enough travelers have not confirmed to join the trip (540), then the original traveler may identify additional travelers to join the trip (520).

Once enough travelers have joined, then the system will attempt to match destinations to the travel criteria (550). The destinations matched with the travel criteria are then presented to all participating travelers for ranking (560). Ranking can occur in several ways. In one embodiment the travelers will rank each trip individually on a scale of 1 to 10, or some other range. In another embodiment the travelers will rank each trip against each other trip to produce a list from most preferred, to least preferred. A traveler (not necessarily the first traveler) selects from the ranked list and invites the other travelers to confirm participation in that specific trip (570). If there is enough participation in that trip (580), then the system books the travel for all participants (590), attempting to accommodate their preferences according to their on individual travel profiles. If there is not enough confirmed participation in a specific trip (580), then a traveler (not necessarily the first traveler) may select again from the ranked list and invite other travelers (570).

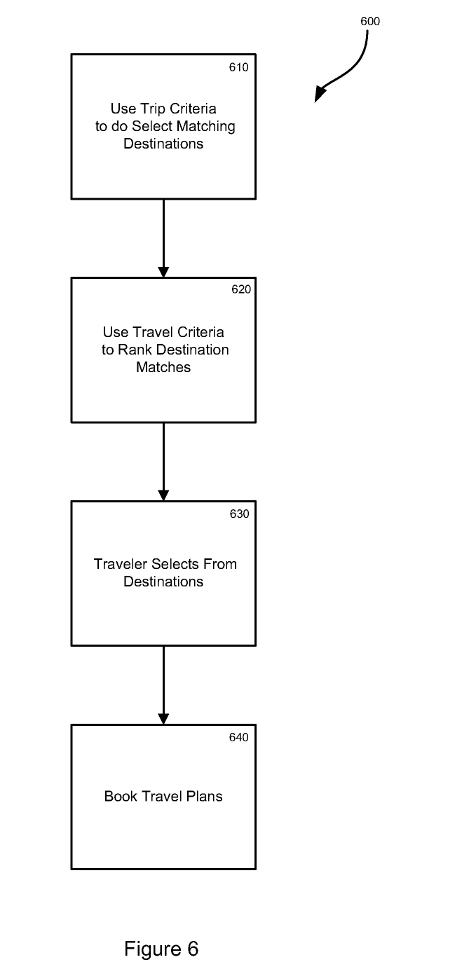

FIG. 6 shows the destination match flowchart (600). The destination match flowchart (600) shows the process of determining travel destinations and booking travel plans. First the trip criteria is used to perform selection matching of destinations (610) by determining destinations which have characteristics matching the trip criteria. Once destinations are selected, the system compares each destination to the traveler's established travel criteria and ranks the destinations based on how well each matches the travel criteria (620). The user then select from the destinations (630). Since they are ranked according to how well they match travel criteria higher ranked destinations have a higher probability of being selected. However, lower ranked destinations may represent options which the traveler may enjoy, but had not considered. Once the traveler selects a destination (630), the system can be used to book travel plans (640).

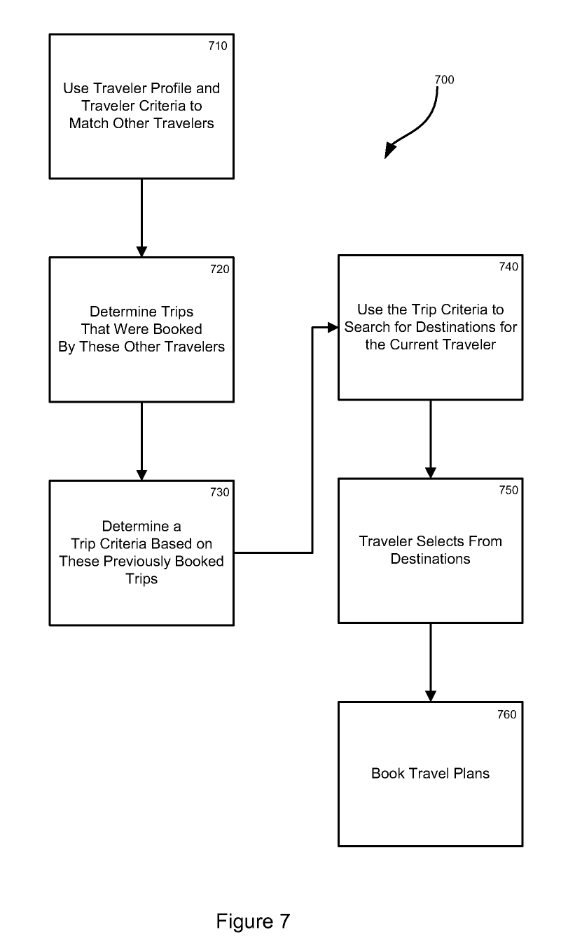

FIG. 7 shows an alternative destination match flowchart (700). This alternative destination match flowchart (700) shows an alternative process of determining travel destinations and booking travel plans. After a traveler establishes a traveler profile and trip criteria by a process similar to that illustrated in FIG. 4, the traveler profile and traveler criteria are used to match other travelers (710). This can be through a social network as illustrated in FIG. 2, or it can be other travelers in the system. Once other travelers with similar traveler profiles are determined, trips previously booked by these other travelers are determined (720). These booked trips are used to establish a new trip criteria (730). One way to do this is by comparing each trip and extracting only the common information between each trip. Another method may be to use the data from each trip to establish a union of the information and using that union as the trip criteria.. Another method may be to use the data from each trip to establish an intersection of the information and using that intersection as the trip criteria. Use the new trip criteria to search for destinations for the current traveler (740). Present the user a list of destinations found from which to pick (750). Book travel plans for the destinations selected by the traveler (760).

In an alternative embodiment travelers can, thorough social networking sites, have their friends and family view proposed destinations and rank or comment on them. Further, friends and family who have taken similar trips, or attended the same destinations may suggest itinerary changes before a trip is booked. After giving a sufficient time for the input of others through the travel planning system, the traveler then has the opportunity to adjust the original trip parameters based on the feedback of family and friends through the social networking site, or they may change the destination based on negative rankings and start again with a new trip planning session.

In another alternative embodiment, friends and family who have traveler profiles on the travel planning system may incorporate a method of designating others with whom they are acquainted with as an alternative to use of a social networking site. Also, rather than booking events as individual components, a traveler's trip criteria may be met by a package travel deal offered by a third party site, or one specifically created for participants by the host or partners of the travel planning tool. In another embodiment, a plurality of travel packages may be identified that when combined meet the requirements of the traveler's trip criteria.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer program stored on a computer-readable medium comprising:
code to query the traveler characteristics and preferences
code to query a database for travel destinations;
code to present travel options to the traveler; and
code to query the traveler as to option preference.

2. A computer program as described in 1 stored on a computer-readable medium comprising:
code to query the traveler characteristics and preferences
code to query a database for travel destinations;
code to present travel options to the traveler; and
code to query the traveler as to option preference.

3. A database of traveler information comprising:
characteristics of a traveler;
preferences of a traveler;
characteristics of travel destinations;
travel options presented to a traveler during a session; and
travel options selected by the traveler during the session.

4. A method of organizing travel arrangement comprising:
determining the characteristics of a traveler;
determining the preferences of a traveler;
determining the characteristics of travel destinations;
matching the traveler with potential destinations; and
presenting the traveler with options from which to choose travel arrangements.

5. The method of organizing travel arrangements, as described in claim 4, further comprising:
determining the characteristics of one or more additional travelers;
determine the preferences of one or more additional travelers; and
presenting the plurality of travelers with options for choosing travel companions.

6. The method of organizing travel arrangements, as described in claim 5, wherein the one or more additional travelers are selected from connections and/or associations within social networks of the travelers.

7. The method of organizing travel arrangements, as described in claim 4, further comprising providing the traveler with list of information associated with travel options selected comprising a plurality of the following:
passport and/or visa requirements for the travel;
government regulations associated with travel in the area;
recommended vaccines;
average historical weather for advanced travel dates, or actual weather predictions for near travel date;
electrical converter requirements for accessories;
equipment checklist for specific activities;
basic traveler phrases for areas in which the traveler will be passing through;
extensive phrase books for areas where a traveler will stay for extended time;
monetary primers for the areas visited;
travelers check and banking locations in the areas visited.

8. The method of organizing travel arrangements, as described in claim 4, wherein the preferences of a traveler comprises:
desired activities;
mode of transportation;
length of stay; and
cost range of trip.

9. The method of organizing travel arrangements, as described in claim 6, wherein the preferences of a traveler further comprises:
hobbies;
interest; and
travel history.

10. The method of organizing travel arrangements, as described in claim 4, wherein the characteristics of a traveler comprises:
age group;
sex;
health issues; and
reason for travel.

11. The method of organizing travel arrangements, as described in claim 4, wherein the characteristics of a traveler comprises:
membership in travel related programs;
travel preferences; and
hotel preferences.

12. The method of organizing travel arrangements, as described in claim 4, wherein the characteristics of travel destinations comprises:
location;
activities available;
climate;
seasonal usage; and
rates.

13. The method of organizing travel arrangements, as described in claim 4, further comprising matching the traveler with potential travel companions.

14. The method of organizing travel arrangements, as described in claim 13, further comprising presenting a plurality of travel companions with group packages or discounts.

15. The method of organizing travel arrangements, as described in claim 4, wherein the traveler is presented options in the form of a calendar interface.

16. The method of organizing travel arrangements, as described in claim 15, wherein the calendar interface is associated with a spreadsheet interface showing cost associated with travel in a plurality of categories grouped by dates and/or locations.

17. The method of organizing travel arrangements, as described in claim 4, wherein presenting the travel with options further comprises:
a) querying a database of traveler history to determining additional traveler histories in the database which have characteristics similar to that of the first traveler;
b) determining travel options represented in the travel histories which are similar to the preferences of the first traveler;
c) determining current travel options similar to those determined in step b; and
d) presenting the first traveler with the current travel options determined in step c.

18. The method of organizing travel arrangements, as described in claim 4, wherein matching the traveler with potential destinations comprises:
a) determining the best time for travel to a location by considering:
the climate,
health risk,
natural disasters, and
travel advisories.

19. The method of organizing travel arrangements, as described in claim 18, wherein matching the traveler with potential destinations further comprises:
b) determining the best time for travel to a location by considering:
local activities, and
interest of the traveler; and
c) if the best time determined in step b conflicts with the best time determined in step a, then using the best time as determined in step b.

20. The method of organizing travel arrangements, as described in claim 4, wherein matching the traveler with potential destinations comprises:
a) determining the tourist season for a location by considering:
special events at the location, and
peak number of travels recorded at a location for specific time intervals throughout the year.
